(19) United States
(12) Patent Application Publication
(10) Pub. No.: US 2006/0095733 A1
(43) Pub. Date: May 4, 2006

(54) Hardware device for executing conditional instruction out-of-order fetch and execution method thereof

(75) Inventors: Yong-surk Lee, Seoul (KR); Ha-young Jeong, Incheon (KR); Nam-guk Kim, Seoul (KR); Jin-oo Joung, Yongin-si (KR); Tae-ho Jang, Gunpo-si (KR); Dae-ung Kim, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/219,797

(22) Filed: Sep. 7, 2005

(30) Foreign Application Priority Data
Sep. 8, 2004 (KR) 2004-71777

(51) Int. Cl. G06F 9/30

(52) U.S. Cl. 712/217

(57) ABSTRACT

A hardware device for executing conditional instructions out-of-order and the execution method. An architecture is provided, enabling the hardware device such as a processor supporting the conditional instruction and a computer system to execute the instruction out-of-order. To this end, a conditional execution buffer is provided, and a register of a destination operand of the conditional instruction is renamed to another register. Hence, the hardware device using the conditional instruction can carry out the out-of-order execution, and the execution speed of the hardware device can be greatly improved.

### CROSS-REFERENCE TO RELATED APPLICATION

This application claims the benefit under 35 U.S.C. § 119 (a) from Korean Patent Application No. 2004-71777 filed on Sep. 8, 2004 in the Korean Intellectual Property Office, the entire disclosure of which is incorporated herein by reference.

### BACKGROUND OF THE INVENTION

1. Field of the Invention

The present invention relates generally to a hardware device for issuing and executing a conditional instruction and the execution method thereof. More particularly, the present invention relates to a hardware device which issues and executes conditional instructions out-of-order, thus improves a performance of a processor.

2. Description of Related Art

Hardware devices such as processors have been improved to have a higher speed for instruction execution and to issue and execute a plurality of instructions at the same time during a single cycle.

However, branch instructions hinder the performance improvement of the processors and restrict issuable instructions. The processors need a proper hardware configuration for branch prediction of the branch instructions, and need to erase all execution results of instructions executed after the branch instructions when the branch prediction is wrong. These requirements cause the performance degradation.

In this regard, some processors reduce the branch instructions in use by adopting conditional instructions. The ‘conditional instructions’ are executed under a specified condition. Table 1 shows examples of the branch instructions and conditional instructions.

TABLE 1

| Examples of branch instruction | | Examples of conditional instruction | |
|---|---|---|---|
| CMP | a, 0 | CMP | a. 0 |
| BREQ | L1 | ADDEQ | x, a, 1 |
| ADD | x, a, 10 | ADDNE | x, a, 10 |
| BR | L2 | | |
| L1: ADD | x, a, 1 | | |
| L2: | . . . | | |

As for the branch instructions in Table 1, an instruction CMP is executed to compare two operands a and 0. If the result is that the two operands are equal, a branch instruction BREQ is issued to execute the L1 phase.

The execution result of the condition causes to execute the instructions out-of-order. Conversely, if the two operands are not equal according to the comparison, it is directed to sequentially execute an instruction ADD to add a and 10.

As for the conditional instructions in Table 1, the same result as the branch instructions are obtained. Meanwhile, after executing an instruction CMP, if the two operands are equal, a conditional instruction ADDEQ, which adds a and 1, is executed. If the two operands are not equal, a conditional instruction ADDNE, which adds 1 and 10, is executed in order.

The conditional instructions can reduce the number of the branch instructions and prevent the performance degradation due to the failure of the branch prediction. The reduced number of the branch instructions denotes a larger block size. The block size is a size of the instruction executable at a time by a basic processor.

A superscalar processor or a very long instruction word (VLIW) processor, which can issue and execute a plurality of instructions during a single cycle, is able to issue multiple instructions at a time. However, since the conditional instruction depends on the condition generated from the execution of the previous instruction, it is hard to execute the conditional instructions out-of-order.

The ‘out-of-order’ execution does not sequentially process instructions according to a program, but processes executable instructions first regardless of their order.

Primarily, processors execute instructions of the program ‘in order’. Thus, initial processors have executed the program in order and the system processes a state of a processor including a register designated in the program in order.

On a logical base, a certain instruction may be skipped and the following instruction can be issued and processed instead, if it is not affected from data dependency which occurs when an instruction depends on the execution result of a previous instruction, or if there is no resource conflict during the processing of the instruction. Thus, the out-of-order execution can greatly improve the performance of the processor.

Conventional processors supporting the conditional instructions include Alpha 21264 microprocessor and IA-64 of INTEL® Corp., and an ARM microprocessor of Advanced RISC Machines (ARM®) Ltd. A problem lies in that the conventional processes do not support the out-of-order execution while using the conditional instructions. This is because it is hard to support the out-of-order execution due to the data dependency when using the status that is generated from the result of the previous instruction.

When the conditions of the conditional instruction are stored in a certain register, a read port is required in addition to a register file. As the processing of the conditional instruction using software changes an instruction set architecture (ISA), compatibility with the legacy program may be lost. Accordingly, a processor is required for the out-of-order execution while using the conditional instruction.

### BRIEF SUMMARY

An aspect of the present invention has been provided to solve the above-mentioned and other problems and disadvantages occurring in the conventional arrangement, and an aspect of the present invention provides a hardware device for supporting and executing conditional instructions out-of-order to improve performance of the hardware device and method for executing the conditional instruction out-of-order.

According to an aspect of the present invention, a hardware device for executing a conditional instruction out-of-order includes: a decode and issue section for fetching at least one of a condition setter instruction for setting a condition, a conditional instruction executed depending on a result of the condition setter instruction, and a condition user instruction for using a result of the conditional instruction, and the decode and issue section for issuing the fetched instruction out-of-order by renaming a register of a destination operand to a separate register with respect to the conditional instruction; an execution section including at least one executor to execute the issued instruction; a condition processing section including the renamed register that stores renaming information, a condition, and the result of the conditional instruction, and the condition processing section for outputting the stored result of the conditional instruction by retrieving a valid conditional instruction of which a condition is satisfied by the result of the condition setter instruction; and a register file for storing the result of the conditional instruction, that is output from the condition processing section, to the original register.

The decode and issue section may include: a decoder for fetching the at least one instruction, renaming the register of the destination operand to another register and outputting the fetched instruction when the fetched instruction is a conditional instruction, and waiting for a result of the valid conditional instruction to be stored in the register file and outputting the fetched instruction when the fetched instruction is a condition user instruction; and an instruction issue queue for assigning an issue queue entry to the instruction output from the decoder, and issuing the instruction to the execution section when there is an available executor for executing the instruction in the execution section.

The condition processing section may include: a condition setting pointer for indicating the entry assigned to the condition setter instruction by the instruction issue queue; a conditional execution buffer for assigning renaming information being the renamed register information received from the decoder and the original register information, a condition, and a buffer entry that stores issue queue entry information indicated by the condition setting pointer, to each of the at least one conditional instruction; a condition checker for requesting a condition of the conditional instruction that is executed depending on the result of the condition setter instruction to the conditional execution buffer when the result of the condition setter instruction is received from the execution section, comparing with the result of the condition setter instruction, and selecting a conditional instruction that satisfies the condition; and a conditional execution register file for receiving the result of the conditional instruction from the execution section and temporarily storing the result of the conditional instruction in the renamed register.

The conditional execution buffer may include a buffer in each buffer entry for indicating a valid conditional instruction that satisfies the condition according to the condition check at the condition checker.

The conditional execution buffer may further include a buffer in the buffer entry for indicating whether the buffer entry assigned to the conditional instruction is used, and the buffer entry is used when the decoder renames the register for a newly fetched conditional instruction.

The conditional execution register file may indicate together with the register whether the renamed register is used, and allow to use the register when the decoder renames a register for a new conditional instruction.

The decoder may determine that the instruction is a condition user instruction when the fetched instruction uses the original register stored in the conditional execution buffer, as a source operand.

A computer system can execute a conditional instruction out-of-order using a hardware device that can execute a conditional instruction out-of-order according to an embodiment of the present invention.

According to another aspect of the present invention, an out-of-order execution method of a hardware device supporting a conditional instruction includes: fetching at least one of a condition setter instruction for setting a condition, a conditional instruction executed depending on a result of the condition setter instruction, and a condition user instruction for using a result of the conditional instruction; renaming a register of a destination operand to a separate register with respect to the conditional instruction and issuing an instruction out-of-order when the at least one fetched instruction is issued for the execution; separately storing renaming information and a condition of the conditional instruction; executing the issued instruction and storing a result of the conditional instruction in the renamed register; selecting a valid conditional instruction having the condition that is satisfied by a result of the condition setter instruction, by using the stored renaming information and the stored condition when the executing of the condition setter instruction is completed; and storing a content of the renamed register that stores the result of the valid conditional instruction in an original register.

The instruction may be issued after the result of the valid conditional instruction is stored in the original register when the fetched instruction is a condition user instruction.

According to another aspect of the present invention, a condition setter instruction processing method in a hardware device supporting a conditional instruction includes: fetching a condition setter instruction from a memory and forwarding the fetched condition setter instruction to an instruction issue queue; issuing the instruction stored in the entry of the issue queue out-of-order when the instruction issue queue receives the condition setter instruction and has assigned an issue queue entry; executing an instruction corresponding to the issued instruction and providing an execution result to a register and a condition checker; storing the execution result received in the register; and checking whether the condition of the conditional instruction is satisfied, upon receiving the execution result.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a hardware device for executing conditional instructions out-of-order according to an embodiment of the present invention;

FIG. 2 is a diagram illustrating renaming of the conditional instruction;

FIG. 3 is a flowchart explaining the hardware device processes a condition setter instruction;

FIG. 4 is a flowchart explaining the process in which the hardware device executes the conditional instruction; and

FIG. 5 is a flowchart explaining the hardware device processing the condition user instruction.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

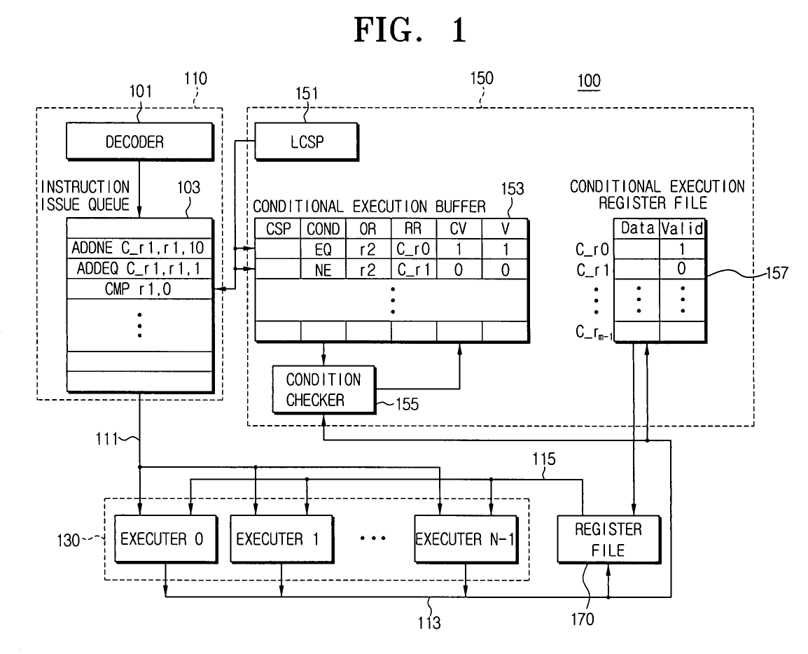

FIG. 1 is a block diagram of a hardware device for executing a conditional instruction out-of-order according to an embodiment of the present invention.

The hardware device is applicable to a microprocessor or a computer system. The hardware device operates according to an electrically stored instruction.

The hardware device can execute a conditional instruction. According to an embodiment of the present invention, the hardware device supports a conditional instruction with respect to all or some of executable instructions.

In the present embodiment, the hardware device is adopted to support out-of-order execution of the conditional instructions. To this end, renaming is used to allocate a plurality of physical destination registers to a register of a destination operand relating to a conditional instruction. The following is an explanation of the renaming in reference to FIG. 2.

FIG. 2 illustrates the renaming of the conditional instruction. In detail, FIG. 2 shows indicates an instruction set A before renaming and a renamed instruction set B containing renamed instructions of the instruction set A.

As for the instruction set A, an instruction CMP compares whether a content of a register r1 is equal to 0. If the content is equal to 0, an instruction ADDEQ is issued to add the content of the register r1 and 1 and store the result in a register r2 which is a destination operand. Conversely, if the content of the register r1 is different from 0, an instruction ADDNE is issued to add 10 to the content and store the result in the register r2. Next, an instruction ADD is issued to add 100 to the result stored in the register r2 and store the obtained result in a register r3 being a destination operand.

The execution of the condition of the instruction CMP enables to determine which one of the following instructions ADDEQ and ADDNE is executed. Hereinafter, a ‘condition setter instruction’ refers to the instruction that determines such as the instruction CMP which of the conditional instructions is to be executed.

There is a conditional instruction that can execute a corresponding instruction only when certain condition is satisfied according to the result of the condition setter instruction. For example, such a conditional instruction includes ADDEQ and ADDNE.

A condition user instruction utilizes the result of the conditional instruction execution. In the instruction set A, the instruction ADD is executed only when a valid conditional instruction is selected from the conditional instructions ADDEQ and ADDNE and when its result is stored in the register r2. Accordingly, even though the condition setter instruction and the conditional instruction can be executed in parallel, the condition user instruction is not executed until a precise condition is determined.

The instruction ADDEQ of the instruction set A may be scheduled to be processed later according to the result of the instruction CMP, and executed and stored in the register r2 before obtaining the result of the instruction CMP. In contrast, the instruction ADDNE cannot be executed together with the instruction CMP or the instruction ADDEQ at the same time because the instruction ADDEQ already uses the register r2 and the result of the instruction CMP is not obtained yet. Thus, the instructions have to be executed in sequence.

The instruction set B contains instructions which are renamed from the destination operand of the conditional instructions to different registers. The register r2 of A′ (indicated by dotted line) is re-allocated to C_r0 and C_r1, respectively in B′ (indicated by dotted line). Accordingly, the instructions ADDEQ and ADDNE are executed together with the instruction CMP in parallel, without having to wait for the result of the instruction CMP, and their results are stored to C_r0 and C_r1, respectively. When the result of the instruction CMP is obtained, only the result of the conditional instruction that satisfies the condition among the results is taken and the rest are discarded. In result, the instruction ADD being the condition user instruction in the instruction set B cannot be executed in parallel.

According to another embodiment of the present invention, all or some of instructions may be renamed to execute a plurality of instruction in parallel. In this case, the instruction set A is already renamed for the purpose of the parallel processing, and the set A′ of the instruction set A that participates in the renaming for the out-of-order execution can also be re-named for parallel processing.

Referring back to FIG. 1, the hardware device is explained particularly when the instruction sets of FIG. 2 are executed.

The hardware device 100 may be equipped in a computer system. The hardware device 100 can be connected to a memory (not shown), a cache (not shown), an input and output (I/O) interface (not shown), and a bus architecture (not shown). The hardware device 100 can be connected by use of the bus architecture to an interface for the connection to a storage device such as hard disk drives (not shown), and computer peripherals such as monitors, keyboards, and modems.

The hardware device 100 may be equipped in a processor that includes a cache (not shown), an I/O interface (not shown), and a bus architecture (not shown).

The hardware device 100 reads an instruction of a program from a memory (not shown) through the cache (not shown) and executes the read instruction. Thus, the hardware device 100 processes and operates as requested by the program.

Still referring to FIG. 1, the hardware device 100 includes a decode and issue section 110, an execution section 130, a condition processing section 150, and a register file 170.

An instruction issue queue 103 and the execution section 130 are connected using an instruction bus 111. The execution section 130, the register file 170, a condition checker 155, and a conditional execution register file 157 are connected using a result bus 113. The register file 170 is connected to the execution section 130 using an operand bus 115.

The decode and issue section 110 includes a decoder 101 and the instruction issue queue 103. The decode and issue section 110 fetches an instruction from the memory (not shown), renames a conditional instruction, and issues the instruction out-of-order to the execution section 130.

The decoder 101 fetches the instruction to be executed from a program stored in the memory (not shown) and forwards the fetched instruction to the instruction issue queue 103. If the hardware device 100 supports the superscalar architecture, the decoder 101 can fetch a plurality of instruction during a single cycle at the same time.

A conditional instruction is decoded to rename a register of the destination operand and is provided to the instruction issue queue 103 and the conditional execution buffer 153. The decoder 101 provides the conditional execution register file 157 with information relating to the renamed register.

If a determination is made that the fetched instruction is the condition user instruction, a valid conditional instruction is selected and the instruction is not transferred to the instruction issue queue 103 until the result of the valid conditional instruction is stored in a corresponding register of the register file 170.

The instruction issue queue 103 uses a top pointer and a bottom pointer to recursively allocate and remove an entry of queue, and issues a valid instruction between the top pointer and the bottom pointer in non-recursive manner to the execution section 130. The top pointer indicates an entry to store a new instruction, and the bottom pointer indicates the oldest entry among entries of the instruction issue queue. As the instructions are issued in non-recursive manner, a following entry may be issued prior to a preceding entry.

With respect to the instructions in the entries, when source registers and data of a source condition register are prepared and there is an available executor in the execution section 130, the instruction issue queue 103 issues each instruction to the execution section 130.

The execution section 130 is responsible for the substantial execution of the instructions. The execution section 130 includes at least one executor. The execution 130 receives the instruction from the instruction issue queue 103 via the instruction bus 111, and reads a value of an operand for the instruction execution from the register file 170 via the operand bus 115. The result of the instruction executed at the execution section 130 is provided to the register file 170, the condition checker 155, and the conditional execution register file 157 via the result bus 113.

The condition processing section 150 includes a latest condition setting pointer (LCSP) 151, a conditional execution buffer 153, and the condition checker 155, and the conditional execution register file 157.

When the conditional instruction is fed from the decoder 101 to the instruction issue queue 103, the LCSP 151 designates an entry 9000 that is allocated from the instruction issue queue 103 (hereinafter, referred to as an issue queue entry) and provides entry information of a corresponding issue queue to the conditional execution buffer 153.

The conditional execution buffer 153 supports the renaming for the out-of-order execution of the conditional instruction according to an embodiment of the present invention. When the conditional instruction is fed into the instruction issue queue 103, the conditional execution buffer 153 allocates one entry for the renamed conditional instruction (hereinafter, referred to as an execution buffer entry). Each entry includes a condition setting pointer (CSP), an execution condition (COND), an original register (OR), a renamed register (RR), a condition valid (CV), and a valid (V) as shown in Table 2.

Table 2 shows entries of the conditional execution buffer 153, that are allocated and set to process the conditional instructions ADDEQ and ADDNE.

TABLE 2

| CSP | COND | OR | RR | CV | V |
|---|---|---|---|---|---|
| 9000 | EQ | r2 | C_r0 | 1 | 1 |
| 9000 | NE | r2 | C_r1 | 1 | 0 |

In Table 2, two entries are assigned for two conditional instructions.

CSP stores the issue queue entry of the condition setter instruction indicated by the LCSP 151. If the result of the condition setter instruction is obtained, the conditional execution instruction that is to use the result can be checked from conditional execution buffer 153.

COND stores the condition of the respective conditional instructions. As for the instruction set B as illustrated in FIG. 2, conditions EQ (indicates equality) and NE (indicates non-equality) for the addition are stored.

OR stores the register of the original destination operand of the conditional instruction. RR stores the register of the renamed destination operand.

CV indicates the valid conditional instruction that satisfies the condition of the relevant COND. Preferably, as for the valid entry, CV is set to 1. As for the invalid entry that fails to satisfy the condition, CV is set to zero. CV may be set to zero until the result of the conditional setter is acquired.

V is a buffer for the entry management. If a relevant entry is determined to be the invalid entry, V is set to zero rather than clearing the entire relevant entry so that the relevant entry can be used to assign an entry with respect to a next conditional instruction.

Upon receiving a request to transfer COND of the same execution buffer entry as the issue queue entry of the condition setter instruction from the condition checker 155, the conditional execution buffer 153 retrieves CSP and provides the condition checker 155 with COND of the same execution buffer entry as the issue queue entry 9000 of the condition setter instruction.

Upon receiving the result of the condition setter instruction and the relevant issue queue entry 9000 from the execution section 130 over the result bus 113, the condition checker 155 requests COND data of the execution buffer entry having the same CSP as the issue queue entry 9000 of the relevant condition setter instruction, to the conditional execution buffer 153. Next, the condition checker 155 compares the received COND with the result of the condition setter instruction. CV of the entry, which satisfies the condition among the entries of the conditional execution buffer 153, is set to 1.

The conditional execution register file 157 includes DATA and Valid buffer. The conditional execution register file 157 receives information relating to the renamed register of the conditional instruction from the decoder 101 and sets to Valid buffer.

When the result of the conditional instruction executed at the execution section 130 is provided with the register address of the renamed destination operand over the result bus 113, the conditional execution register file 157 stores a corresponding result in DATA buffer of a relevant register. For example, as for the instruction set B as illustrated in FIG. 2, the result of the instruction ADDEQ is stored to C_r0 and that of the instruction ADDNE is stored to C_r1.

When the valid conditional instruction is selected according to the condition check at the condition checker 155, the corresponding value stored in the register that is designated by RR of the conditional execution buffer 153 is finally stored to the register file 170 designated by OR of the condition execution buffer 153.

The register file 170 provides the execution section 130 with the register value of the source operand which is required to execute the instruction, receives the result of the instruction from the execution section 130, and stores the result in the register of the corresponding destination operand. In addition, the register file 170 receives the result of the valid conditional instruction from the conditional execution register file 157 and stores the received result in the register designated by OR.

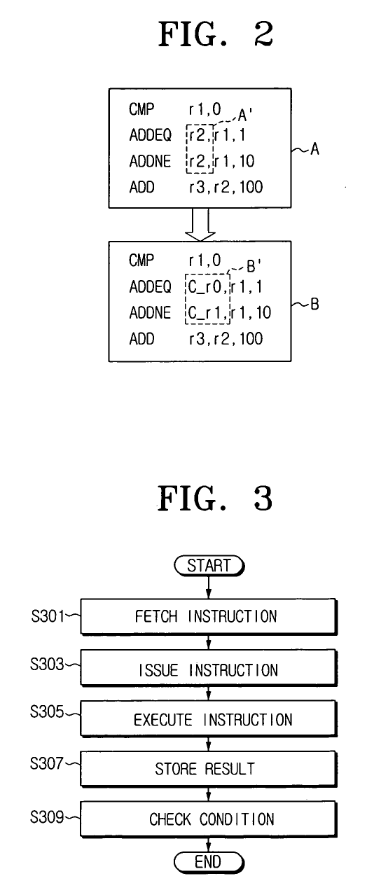

Hereinafter, the execution of the instruction by the type is illustrated based on the instruction sets of FIG. 2 in reference to FIG. 3 through FIG. 5. Although FIG. 3 through FIG. 5 separately explain the execution of the instructions by the type, it is assumed that the condition setter instruction and the conditional instruction of the instructions can be processed in parallel and in the out-of-order execution.

FIG. 3 is a flowchart explaining how the hardware device 100, which executes the conditional instruction out-of-order, processes the condition setter instruction according to an embodiment of the present invention.

Referring to FIGS. 1 and 3, when the condition setter instruction CMP is fetched from the memory (not shown), the decoder 101 forwards the fetched condition setter instruction CMP to the instruction issue queue 103. If the hardware device 100 supports a superscalar architecture, the decoder 101 may fetch a plurality of different instructions during a single cycle at a time (S301).

When the instruction issue queue 103 receives the condition setter instruction and assigns the entry 9000, the LCSP 151 indicates the assigned issue queue entry 9000. The instruction issue queue 103 issues the instruction stored in the entry of the issue queue out-of-order and issues the condition setter instruction to the relevant execution section 130 (S303).

The execution section 130 receives and executes the corresponding instruction, which is stored in the register of the source operand r1 with respect to the instruction CMP, from the register file 170 via the operand bus 115. The execution section 130 provides the result to the register file 170 and the condition checker 155 (S305).

The register file 170 stores the result received from the execution section 130 in the register of the corresponding destination operand (S307). Note that the instruction CMP, which has no destination operand, is not stored in the register file 170.

Upon receiving the result of the condition setter instruction in operation S305, the condition checker 155 checks whether the condition of the conditional instruction is satisfied, no matter whether the result of the conditional instruction is stored in the conditional execution register file 157 or not.

More specifically, to retrieve the conditional instruction relating to the corresponding condition setter instruction, the condition checker 155 requests to the conditional execution buffer 153 the COND value of the execution buffer entry having the same CSP as the issue queue entry of the condition setter instruction. The conditional execution buffer 153 retrieves the execution buffer entry stored as 9000 in CSP and provides the conditions EQ and NE to the condition checker 155.

The condition checker 155 retrieves the conditional instruction that satisfies the condition by use of the condition of COND, and sets CV to 1. If the condition EQ is satisfied as the value stored in r1 equals zero according to the result of CMP, the instruction ADDEQ becomes the valid conditional instruction and the instruction ADDNE becomes invalid conditional instruction. Accordingly, as shown in Table 2, CV of the first entry is set to 1 and the second entry is set to zero (S309).

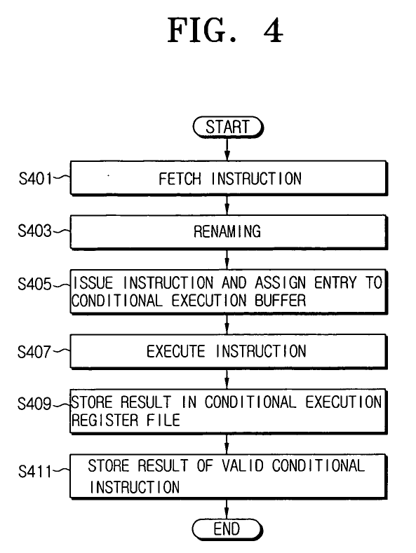

In result, the processing of the condition setter instruction is finished. Note that the result of the condition setter instruction is required to complete the execution of the conditional instruction which will be described in reference to FIG. 4.

FIG. 4 is a flowchart explaining how the hardware device 100 executes the conditional instruction out-of-order according to an embodiment of the present invention.

Referring to FIGS. 1 and 4, when the conditional instructions ADDEQ and ADDNE are fetched from the memory (not shown) (S401), the decoder 101 renames the conditional instructions ADDEQ and ADDNE before forwarding to the instruction issue queue 103 (S403). To this end, the decoder 101 renames the register of the destination operand to the available register by checking the Valid of the conditional execution register file 157. The decoder 101 provides the renamed conditional instruction to the instruction issue queue 103 and provides the renamed register information C_r0 and C_r1 to the conditional execution register file 157 at the same time.

When the instruction issue queue 103 receives the conditional instruction and assigns the entry, the conditional execution buffer 153 also assigns the execution buffer entry for the conditional instruction.

As for the instruction ADDEQ, the conditional execution buffer 153 stores the issue queue entry 9000 of the condition setter instruction which is indicated by the LCSP 151 to CSP in operation S303, and stores the condition EQ to COND, like the first entry as shown in Table. 2. The conditional execution buffer 153 stores the original register r2 in OR, stores the renamed register C_r0 in RR, sets CV to zero, and sets V to 1.

The instruction issue queue 103 issues the instruction stored in the entry of the issue queue out-of-order and issues the conditional instruction to the relevant execution section 130. The instruction may be issued in parallel with the issue of the instruction CMP being the condition setter instruction in operation S303. In short, the instruction is issued out-of-order (S405).

The execution section 130 receives operand that is stored in the register r1 of the source operand with respect to the corresponding instruction ADDEQ, from the register file 170 over the operand bus 115 and executes the corresponding instruction (S407).

The execution section 130 provides and stores the result of the instruction to and in the renamed register of the conditional execution register file 157 (S409). For instance, the instruction ADDEQ as illustrated in FIG. 2 is provided to the register C_r0.

When the condition check ends, the valid conditional instruction is selected, and CV of the relevant execution buffer entry is set in operation S409, the conditional execution register file 157 reads and stores the value of the register designated by RR of the relevant execution buffer entry in the original register of the register file 170 designated by OR (S411).

Therefore, the conditional instruction can be executed.

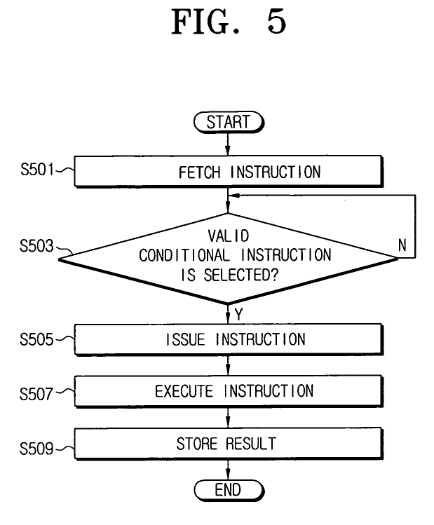

FIG. 5 is a flowchart explaining how the hardware device processes the condition user instruction according to an embodiment of the present invention.

Referring to FIGS. 1 and 5, after fetching the instruction (S501), if the fetched instruction is a general instruction rather than the condition setter instruction or the conditional instruction, the decoder 101 determines whether the fetched instruction is the condition user instruction by checking whether the register r2 of the source operand is designated in OR of the conditional execution buffer 153. The instruction ADD as shown in FIG. 2 uses the destination operand r2 of the conditional instruction as the source operand. In Table 2, since r2 is assigned as OR in operation S405, the instruction ADD becomes the condition user instruction.

Upon determining the condition user instruction, the decoder 101 determines whether the valid conditional instruction is selected according to the result in operation S411 (S503). If the valid conditional instruction is selected, the decoder 101 provides the condition user instruction to the instruction issue queue 103.

The instruction issue queue 103 allocates the entry to the condition user instruction and issues the instruction to the execution section 130 out-of-order (S505). When the execution section 130 executes the condition user instruction (S507), the result is stored in the register file 170 (S509).

Therefore, the instructions can be executed. Although the instructions have been separately illustrated in reference to FIG. 3 through FIG. 5, it is preconditioned that the instructions are executed in parallel.

Since the execution of the condition setter instruction in operations S303 and S305 and the execution of the conditional instruction in operation S405 and S407 have no mutual data dependency by use of the register renaming, the condition setter instruction and the conditional instruction are executed by the instruction issue queue 103 in parallel and out-of-order.

Thus, the hardware device 100 can execute the conditional instruction out-of-order.

As set forth above, the hardware device can execute the conditional instructions out-of-order. Dependency of the conditional instructions is removed through the register renaming. When the number of the executors is sufficient, the condition setter instruction and the conditional instruction can be executed in a single cycle and their results can be selected. Furthermore, the execution speed of the entire system can be enhanced.

Additional instructions are not required because the conditional execution buffer, which is hardware, carries out the out-of-order execution.

Even when the executed conditional instruction becomes invalid because the conditional instruction fails to satisfy the execution condition despite the register renaming, the entry of the conditional execution buffer can be erased and recovered without having to separately recover the register.

Legacy programs can be re-used owing to the hardware without changing the conventional ISA.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A hardware device for executing a conditional instruction out-of-order, comprising:
a decode and issue section fetching a condition setter instruction for setting a condition, a conditional instruction executed depending on a result of the condition setter instruction, or a condition user instruction for using a result of the conditional instruction, and issuing the fetched instruction out-of-order by renaming a register of a destination operand to a separate register with respect to the conditional instruction;
an execution section including at least one executor to execute the issued instruction;
a condition processing section including the renamed register that stores renaming information, a condition, and the result of the conditional instruction, and outputting the stored result of the conditional instruction by retrieving a valid conditional instruction of which the condition is satisfied by the result of the condition setter instruction; and
a register file storing the result of the conditional instruction, that is output from the condition processing section, to the original register.

2. The hardware device of claim 1, wherein the decode and issue section comprises:
a decoder fetching the instruction, renaming the register of the destination operand to another register and outputting the fetched instruction when the fetched instruction is a conditional instruction, and waiting for a result of the valid conditional instruction to be stored in the register file and outputting the fetched instruction when the fetched instruction is a condition user instruction; and
an instruction issue queue assigning an issue queue entry to the instruction output from the decoder, and issuing the instruction to the execution section when there is an available executor for executing the instruction in the execution section.

3. The hardware device of claim 1, wherein the condition processing section comprises:
a condition setting pointer indicating the entry assigned to the condition setter instruction by the instruction issue queue;
a conditional execution buffer assigning renaming information which is the renamed register information received from the decoder and the original register information, a condition, and a buffer entry that stores issue queue entry information indicated by the condition setting pointer, to each of the at least one conditional instruction;
a condition checker requesting a condition of the conditional instruction that is executed depending on the result of the condition setter instruction to the conditional execution buffer when the result of the condition setter instruction is received from the execution section, comparing with the result of the condition setter instruction, and selecting a conditional instruction that satisfies the condition; and
a conditional execution register file receiving the result of the conditional instruction from the execution section and temporarily storing the result of the conditional instruction in the renamed register.

4. The hardware device of claim 3, wherein the conditional execution buffer comprises a buffer, in each buffer entry, indicating a valid conditional instruction that satisfies the condition according to the condition check at the condition checker.

5. The hardware device of claim 3, wherein the conditional execution buffer further comprises a buffer, in the buffer entry, indicating whether the buffer entry assigned to the conditional instruction is used, and the buffer entry is used when the decoder renames the register for a newly fetched conditional instruction.

6. The hardware device of claim 3, wherein the conditional execution register file indicates together with the register whether the renamed register is used, and allows to use the register when the decoder renames a register for a new conditional instruction.

7. The hardware device of claim 3, wherein the decoder determines that the instruction is a condition user instruction when the fetched instruction uses the original register stored in the conditional execution buffer, as a source operand.

8. A computer system for executing a conditional instruction out-of-order using a hardware device, the hardware device comprising:
a decode and issue section fetching a condition setter instruction for setting a condition, a conditional instruction executed depending on a result of the condition setter instruction, or a condition user instruction for using a result of the conditional instruction, and issuing the fetched instruction out-of-order by renaming a register of a destination operand to a separate register with respect to the conditional instruction;
an execution section including at least one executor to execute the issued instruction;
a condition processing section including the renamed register that stores renaming information, a condition, and the result of the conditional instruction, and outputting the stored result of the conditional instruction by retrieving a valid conditional instruction of which the condition is satisfied by the result of the condition setter instruction; and
a register file storing the result of the conditional instruction, that is output from the condition processing section, to the original register.

9. An out-of-order execution method of a hardware device supporting a conditional instruction, comprising:
fetching a condition setter instruction for generating a condition, a conditional instruction executed depending on a result of the condition setter instruction, or a condition user instruction for using a result of the conditional instruction;
renaming a register of a destination operand to a separate register with respect to the conditional instruction and issuing an instruction out-of-order when the fetched instruction is issued for the execution;
separately storing renaming information and a condition of the conditional instruction;
executing the issued instruction and storing a result of the conditional instruction in the renamed register;
selecting a valid conditional instruction having the condition that is satisfied by a result of the condition setter instruction, by using the stored renaming information and the stored condition when the executing of the condition setter instruction is completed; and
storing a content of the renamed register that stores the result of the valid conditional instruction in an original register.

10. The out-of-order execution method of claim 9, wherein the instruction is issued after the result of the valid conditional instruction is stored in the original register when the fetched instruction is a condition user instruction.

11. A condition setter instruction processing method in a hardware device supporting a conditional instruction, comprising:
fetching a condition setter instruction from a memory and forwarding the fetched condition setter instruction to an instruction issue queue;
issuing the instruction stored in the entry of the issue queue out-of-order when the instruction issue queue receives the condition setter instruction and has assigned an issue queue entry;
executing an instruction corresponding to the issued instruction and providing an execution result to a register and a condition checker;
storing the execution result received in the register; and
checking whether the condition of the conditional instruction is satisfied, upon receiving the execution result.
